(19) United States
(12) Patent Application Publication
(10) Pub. No.: US 2017/0118066 A1
(43) Pub. Date: Apr. 27, 2017

(54) DATA PLANE TO FORWARD TRAFFIC BASED ON COMMUNICATIONS FROM A SOFTWARE DEFINED (SDN) CONTROLLER DURING A CONTROL PLANE FAILURE

(71) Applicant: HEWLETT PACKARD ENTERPRISE DEVELOPMENT LP, Houston, TX (US)

(72) Inventors: Subin Cyriac MATHEW, Bangalore (IN); Sugesh CHANDRAN, Bangalore (IN)

(73) Assignee: Hewlett-Packard Development Company, L.P., Houston, TX (US)

(21) Appl. No.: 15/307,890

(22) PCT Filed: Aug. 13, 2014
(86) PCT No.: PCT/US2014/050858

§ 371 Date: Oct. 31, 2016

(30) Foreign Application Priority Data
Apr. 30, 2014 (IN) 2196/CHE/2014

(51) Int. Cl. H04L 12/24; H04L 29/08; H04L 12/46; H04L 12/703

(52) U.S. Cl. CPC H04L 41/0663; H04L 41/0668; H04L 45/28; H04L 67/141; H04L 12/4633; H04L 41/20

(57) ABSTRACT

Examples herein disclose detecting when a control plane within a switch suffers a failure. The failure of the control plane is communicated to a software defined networking (SDN) controller. A data plane forwards traffic based on communications with the SDN controller.

### BACKGROUND

Software defined networking (SDN) is an approach to computer networking which decouples a networking system. The decoupling may be accomplished by separating the system that makes decisions about where traffic is sent (e.g., a control plane) from the underlying systems that forward traffic to a selected destination (e.g., a data plane).

### BRIEF DESCRIPTION OF THE DRAWINGS

In the accompanying drawings, like numerals refer to like components or blocks. The following detailed description references the drawings, wherein:

FIG. 1 is a block diagram of an example switch including a module to detect when a control plane is experiencing a failure and communicates with a software defined networking (SDN) controller and a data plane within the switch forwards traffic despite the control plane failure;

FIG. 2A is a block diagram of an example networking system including hybrid switches operating between a legacy network and a software defined networking (SDN) network;

FIG. 2B is a block diagram of an example switch including a control plane experiencing a failure and a module operating as an agent within each slot of the switch, the agent modules communicate with an SDN controller over an auxiliary channel upon detection of the control plane failure;

FIG. 3 is a flowchart of an example method executable by a networking device to detect a control plane failure and communicate between a data plane and an SDN controller, the networking device proceeds to forward traffic based on the communications from the SDN controller;

FIG. 4 is a flowchart of an example method by a networking device to detect when a control plane suffers a failure and in turn, communicate between a data plane and an SDN controller for forwarding traffic; and

FIG. 5 is a block diagram of an example computing device with a processor to execute instructions in a machine-readable storage medium for detecting a control plane failure, receiving a communication from an SDN controller, and forwarding traffic from the data plane.

### DETAILED DESCRIPTION

In networking systems, a networking switch may be used between different networks, such as an SDN network and/or legacy network. When the switch is operating in this hybrid model between different networks, the switch control plane may consist of multiple legacy network applications which control the way traffic is forwarded in the legacy network. The switch control plane may operate an SDN module which maintains a primary communication channel between a network device and an external controller (e.g., SDN controller). Additionally, the control plane may program a forwarding table as instructed by the SDN controller. The network switch may process traffic at a control plane to determine where to forward traffic and as such, a data plane within the network switch may forward the traffic accordingly. When the control plane suffers a failure, the entire networking switch may be taken down, thus causing many disruptions in traffic. The networking switch may include a redundant control plane, but this may be costly in resources and real estate.

To address these issues, examples disclosed herein provide a more efficient approach to a networking system when a control plane within a switch suffers a failure. In this manner, the switch may continue operations despite the control plane failure. The switch may include a module which detects when the control plane suffers the failure. Upon the detection of the failure, the module may communicate with a software defined networking (SDN) controller. The communication may indicate to a data plane within the switch to continue forwarding traffic based on existing forwarding table entries. The module enables the switch to perform tasks such as maintaining communication with the SDN controller, disabling specific ports, and/or blocking virtual local area networks.

In another example discussed herein, the data plane forwards traffic based on existing programmed flows into an SDN network. This enables the switch to continue operations despite the control plane failure and further allows traffic directed to the SDN network. The data plane continues operations of at least one port associated with the SDN network, thus forwarding traffic in the SDN network. Additionally, forwarding traffic based on existing programmed flows in the SDN network enables traffic to be forwarded without disruption.

In summary, examples disclosed herein provide a more efficient approach to a networking system when a control plane within a switch suffers a failure. In these examples, the switch which may continue operations despite a control plane failure. This enables the switch to forward traffic based on existing SDN programmed flows without disruption.

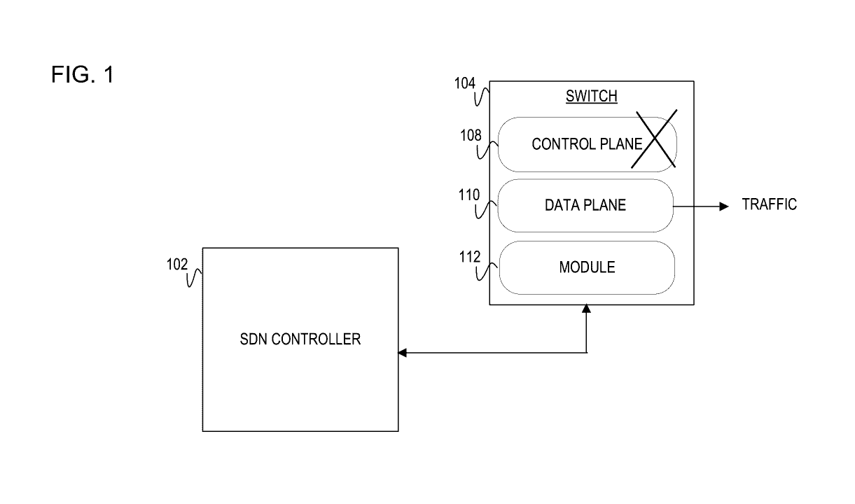

Referring now to the figures, FIG. 1 is a block diagram of an example switch 104 including a module 112 to detect when a control plane 108 is experiencing a failure. The module 112 may communicate with a software defined networking (SDN) controller information on the failure. Upon communicating with the SDN controller, a data plane 110 may then forward traffic accordingly. The SDN controller 102 and the switch 104 illustrate a networking system which may receive incoming traffic and forward the traffic to the appropriate destination. These networking systems may include wide area network (WAN), legacy network, local area network (LAN), Ethernet, optic cable network, SDN network, or other type of networking system.

The switch 104 is a networking device which may provide a connection between networks and/or networking devices. The switch 104 may process traffic (e.g., packet(s)) at the control plane 108 to determine the path in which to forward the traffic. The switch 104 may then program the data plane 110 for forwarding the traffic. As such, the switch 104 may transmit the traffic to the data plane 110. The data plane 110 may then forward the traffic out of the switch 104 to the appropriate destination. The destination path in which to route traffic may also be referred to as programmed flows. The programmed flow is a path in which a particular packet may take according to header information and/or control information from the packet. In this manner, the programmed flows may be illustrated in a forwarding table with control information from particular packet to the particular ports in which to egress the packets to route the packets to the appropriate destination. For example, the data plane 110 may use information from the control plane 108 to determine where to forward traffic. As such, the data plane 110 refers to the forwarding table to look up traffic and decide how to handle the traffic. In implementations, the switch 104 may include a point to point connection with another networking device. In further implementations, the switch 104 may be part of a hybrid switch between a legacy network and an SDN network. Implementations of the switch 104 include a multi-port network device, multi-layer switch, or other type of networking device capable of providing the physical connections through wired connections or wireless connections between networking devices. Although FIG. 1 illustrates the switch 104 as including components 108, 110, and 112, implementations should not be limited as this was done for illustration purposes. For example, the switch 104 may further include a port and switch fabric.

The control plane 108, is part of the switch 104 architecture that is concerned with drawing the networking map. The networking map may include a forwarding table that dictates what to do with particular incoming traffic. In a legacy network, the control plane is located on the switch 104, while in an SDN network, the control plane may be located externally to the switch 104. The control plane 108 represents the switch control plane. For example, for the SDN enabled port(s) and/or vlans, the switch control plane 108 may act as a control channel to send unknown packets to the SDN controller 102, receive flow rules from the SDN controller 102, and program the data plane 110, accordingly. The forwarding table based on these may send out packets through specific egress ports as instructed. In another implementation, the forwarding table may include programmed flows in the sense the table may list where to forward a particular packet. As such, the control plane 108 may include a method for communicating what to do with incoming packets with particular control information to the data plane 110. The control plane 108 may experience a failure as indicated with ‘X,’ meaning the control plane 108 may not be within normal operation and thus unable to handle traffic. For example, the control plane 108 may be unable control the legacy network traffic as well as losing a primary communication channel for communications from the control play 108 to the SDN controller 102. As such, the control plane 108 may signal to the module 112 it may not be within normal operation, thus indicating the failure. In another implementation, the module 112 may monitor the control plane 108 for the failure. If the module 112 determines the control plane 108 is experiencing failure, the module 112 may proceed to communicate the failure to the SDN controller 102.

The data plane 110 is part of the switch 104 architecture that forwards traffic. Prior to the control plane 108 failure, the data plane 110 may use information from the control plane 108 to determine where to forward traffic. As such, the data plane 110 refers to the forwarding table to look up traffic and decide how to handle the traffic. For example, the data plane 110 may refer to the table and look up a destination address of incoming traffic and may retrieve the information to determine the path or flow of the traffic. In this manner, the data plane 110 forwards traffic based on existing programmed flows.

The module 112 is a component in between the data plane 110 and the SDN controller 102. The module 112 may detect when the control plane 108 has suffered the failure and communicate this information to the SDN controller 102. The SDN controller 102 may continue with existing programmed flows in the forwarding table in the data plane 110. The SDN controller 102 may also re-route traffic through adjacent switches through programming each of the adjust switch(es), thus bypassing the switch 104 which may be encountering the control plane 108 failure and/or control plane 108 reboot. In this implementation, the controller 102 may instruct the switch 104 to bring specific ports down or to bring down line cards and enable the specific ports and/or line cards to come back up when the control plane 108 has rebooted. In one implementation, the module 112 operates as a slave agent to the SDN controller 102. The module 112 may be located within an application specific integrated circuit (ASIC) or within a line card at a processor. This implementation is explained in detail in the next figures.

The SDN controller 102 may communicate with the module 112 upon the detection of the control plane 108 failure. The SDN controller 102 is a networking device that is part of the SDN network (not illustrated). As such, the SDN controller 102 may manage the flow of packets through the SDN network. In one implementation, the SDN controller 102 operates as a master device while the module 112 operates as a slave device. The SDN controller 102 receives the communication from the module 112 indicating the control plane 108 failure. The SDN controller 102 in turn may make a decision of whether to continue with existing programmed flows from the control plane 108 or to re-route the traffic through the switch 104 via other neighboring networking devices. The SDN controller 102 is a hardware component which connects computing devices to the networking system and as such, implementations of the SDN controller 102 may include a networking device, interface controller, processing device, or other type of networking controller. In one implementation, a control plane on the SDN controller communicates with the switch control plane 108 through OpenFlow, an example communications protocol that can be used for SDN networks.

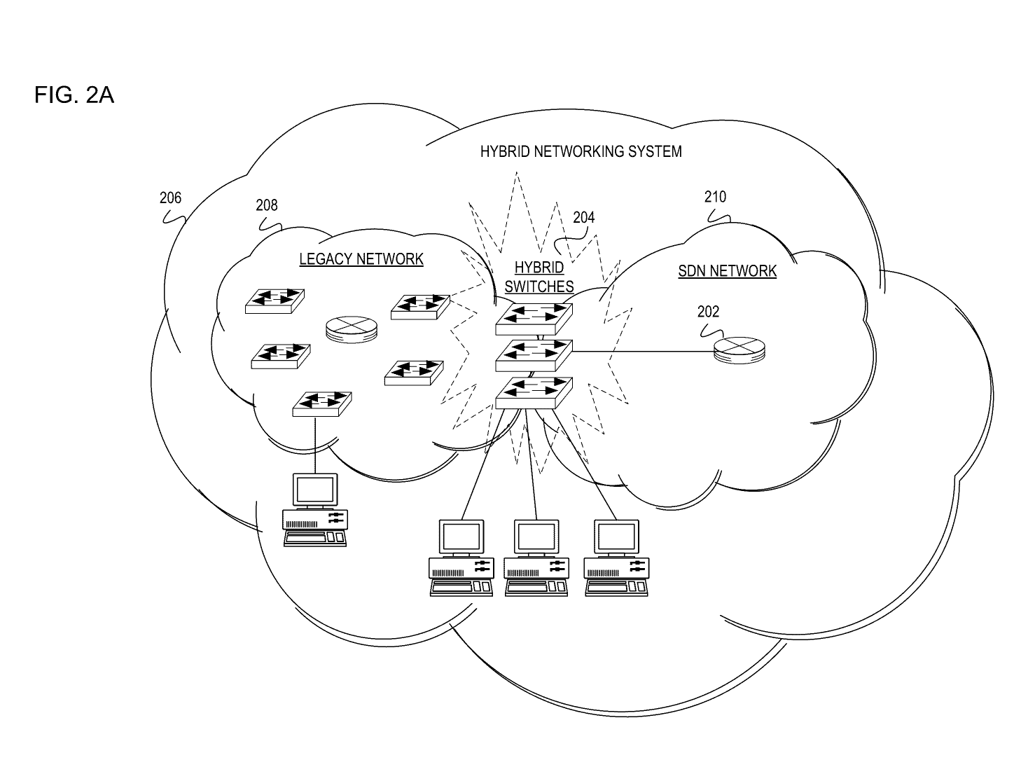

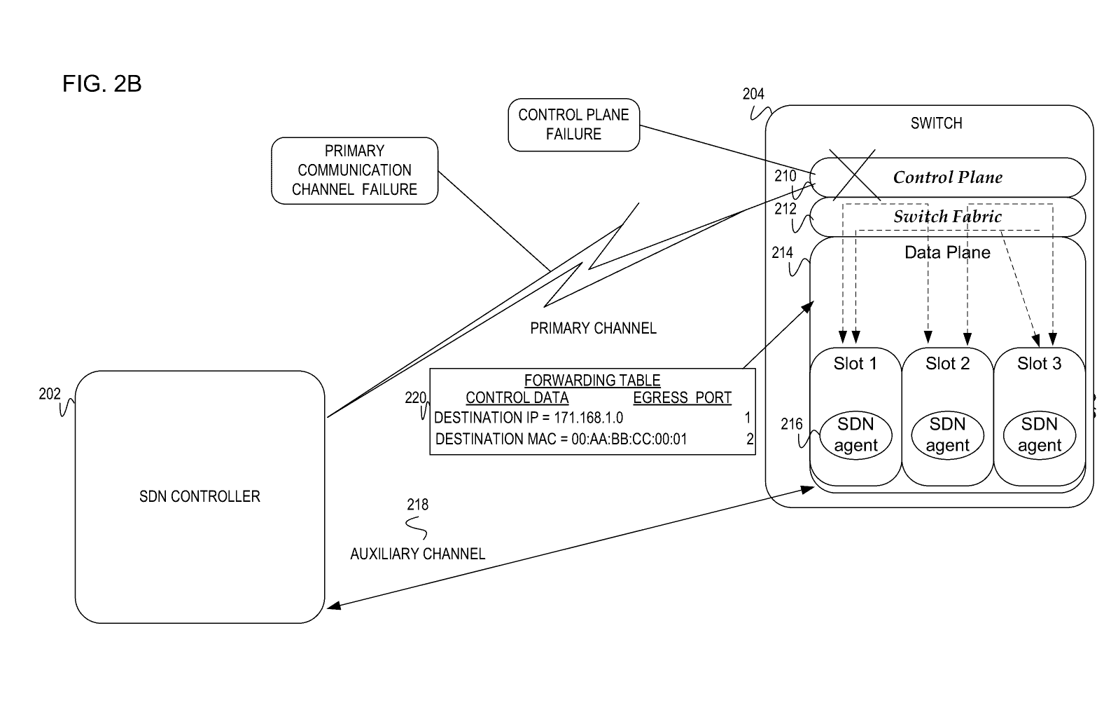

FIG. 2A is a block diagram of an example hybrid networking system 206 including hybrid switches 204 operating between a legacy network 208 and an SDN network 210. One of the hybrid switches 204 may communicate with an SDN controller 202 upon a control plane failure within that hybrid switch. The hybrid networking system 206 illustrates how ports on each of the hybrid switches 204 may route traffic through each of the networks 208 and/or 210. For example, each of the hybrid switches 204 may include at least one port for connecting to the legacy network 208 and at least one port for connecting to the SDN network 210. In this example, a module may be located at each of the hybrid switches 204. Thus, the module may communicate with the SDN controller 210 by transmitting information regarding each of these ports. In this manner, the module may disable or bring down those ports which may not be SDN network 210 enabled (e.g., legacy network 208 enabled ports). Further in this example, the control plane may be part of the legacy network, thus to eliminate the non-SDN enabled traffic (i.e., legacy network 208 traffic), the non-SDN ports are disabled. In another implementation, each of the networks 206, 208, and 210 may include a topology in which traffic may flow. In this example, one of the computing devices may access various types of switches (distribution switch, core switch) prior to reaching another network. The hybrid switches 204 and the SDN controller 202 may be similar in structure and functionality to the switch 104 and SDN controller 102 as in FIG. 1. Although FIG. 2A illustrates the SDN controller 202 within the SDN network 210, this was done for illustration purposes as the SDN network 210 may further include switches operating within the SDN network 210 and computing devices accessing the SDN network 210. Additionally, there may be additional components within each of the networks 208 and/or 210 which may not be illustrated. For example, the legacy network 208 may include additional controller, switches, computing devices, etc.

FIG. 2B is a block diagram of an example switch 204 including a control plane 210 experiencing a failure. Upon the failure of the control plane 210, a primary channel may also be taken down. The SDN agent 216 on each slot may detect a switch control plane 210 failure either through a heartbeat message failure over the switch fabric 212 or by a direct message from the control plane 210. The switch fabric 212 enables an interconnection between the various line cards as well as between the control plane 210 and the data plane 214. The SDN agent 216 may then communicate the control plane 210 failure over an auxiliary channel 218 to an SDN controller 202. Each of the SDN agents 216 are considered a module, such as module 112 as in FIG. 1. In this manner, each of the modules on the switch 204 operate as slave agents to the SDN controller 202. In this implementation, each of SDN agents 216 operate on a processor of each line card (Slot 1, Slot 2, and Slot 3) or within an application-specific integrated circuit (ASIC) within the switch 204. This enables each of the SDN agents 216 to perform tasks such as maintaining communication with the SDN controller 202 over the auxiliary channel 218, disable specific ports, block specific virtual local area networks (VLANs), reporting port statistics etc. Performing these tasks enables the switch 204 to forward traffic based on existing SDN programmed flows so the traffic is forwarded without disruption. In one implementation, the forwarding table 220 may be at the data plane 214 prior the control plane 210 failure. In this manner, the forwarding table 220 at the data plane 214 to describe the programmed flows for traffic into the SDN network 210 as in FIG. 2A.

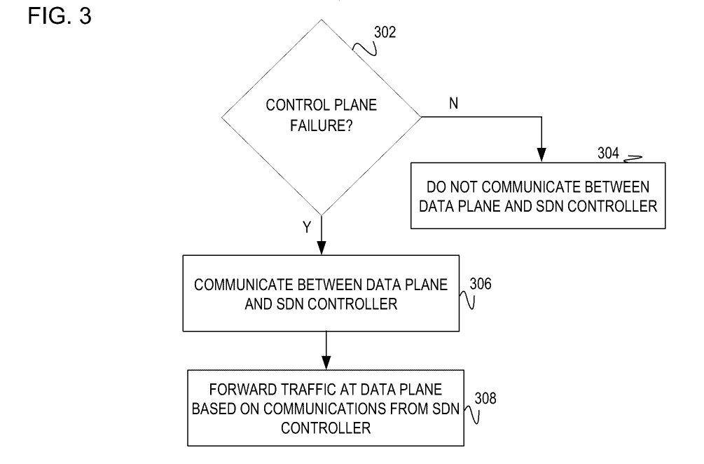

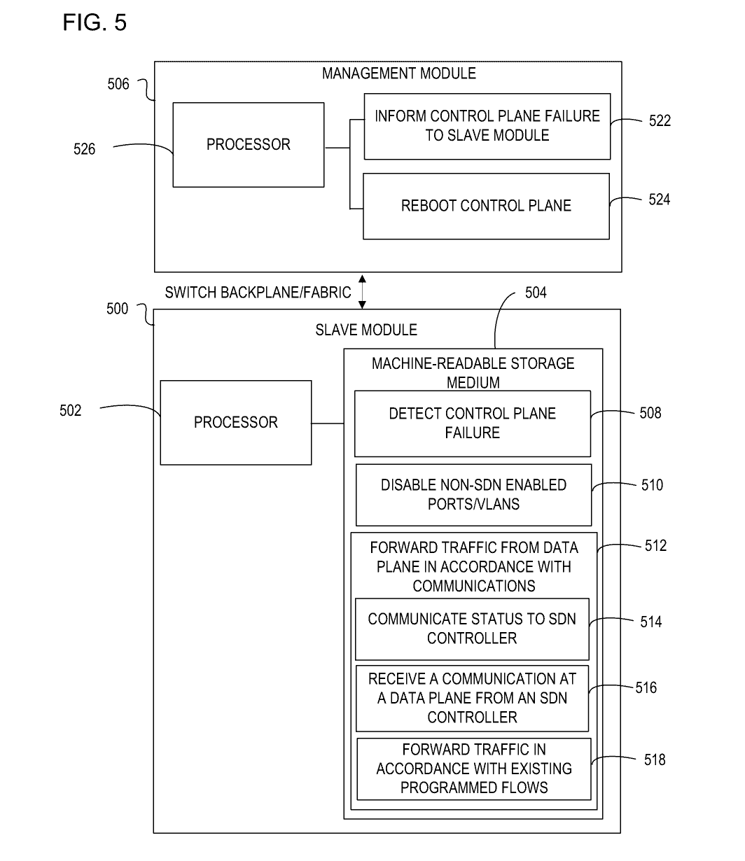

FIG. 3 is a flowchart of an example method executable by a networking device to detect a control plane failure and communicate between a data plane and an SDN controller. Based on the communication from the SDN controller, the networking device may proceed to forward traffic. In discussing FIG. 3, references may be made to the components in FIGS. 1-2B to provide contextual examples. In one implementation, a networking device, such as the switch 104 as in FIG. 1 executes operations 302-308 to detect the control plane failure and forward traffic from the data plane. In another implementation of FIG. 3, the module 112 within the switch 104 as in FIG. 1 executes operations 302-308. Further, although FIG. 3 is described as implemented by the networking device associated with the switch 104 as in FIG. 1, it may be executed on other suitable components. For example, FIG. 3 may be implemented in the form of executable instructions on a machine-readable storage medium 504 as in FIG. 5.

At operation 302, the networking device may detect the control plane failure. The failure of the control plane indicates to the networking device the control plane may not be within normal operation and thus may be unable to make forwarding a decision in the case of a legacy network associated with a port and/or vlan. The control plane may be unable to communicate with the SDN controller as well as risking the possibility of blocking traffic which may be destined for the SDN network. In this implementation, the networking device may disable the ports associated with the legacy network prior to the data plane communicating with the SDN controller. This implementation may be described in detail in the next figure. The control plane may signal to the networking device that it may not be within normal operation thus indicating the failure. In another implementation, the module may monitor the control plane for the failure. If the networking device determines the control plane is experiencing failure, the networking device may proceed to operation 306 to communicate the failure to the SDN controller. If the networking device does not detect the control plane failure, the networking device may proceed to operation 304 and does not communicate to the SDN controller. Detecting the failure at the control plane enables the switch to continue forwarding traffic by maintaining operation of the data plane. This implementation enables other components within the switch to handle traffic and continue operations despite the control plane failure.

At operation 304, upon detecting the control plane has not experienced a failure as at operation 302, the networking device may not communicate to the SDN controller. If the networking device does not detect the failure or other type of issue at the control plane, this may indicate the control plane is in normal operation. At normal operation, the control plane may receive incoming traffic and program the flow entry for which subsequent packets matching the flow should be forwarded. Upon deciding the destination path, the control plane may communicate this information to the data plane for the data plane to forward the traffic so that packets matching the forwarding entry may be forwarded in the data plane itself without consulting the control plane.

At operation 306, the networking device communicates between the data plane and the SDN controller. Based on the communication received by the SDN controller from the networking device, the SDN controller may make an informed decision whether to continue with existing programmed flows and/or whether to re-route the traffic through neighboring network devices. In turn, the SDN controller transmits the decision to the networking device whether to continue or discontinue with existing programmed flows. The existing programmed flows are the destination paths in accordance with previously received traffic. For example, traffic may include a packet with control information and a payload. Thus, the networking device may utilize a forwarding table to determine the destination from previously processed packets. If the control information is new to the networking device, the networking device may transmit that packet to the SDN controller for the SDN controller to determine where to forward. Operation 306 may include transmitting a status of the switch to the SDN controller. The status may include the failure of the control plane and communicating the continued operation of the data plane. The networking device may also communicate information about the particular ports which may be SDN enabled. In one implementation, the communications to the SDN controller may include information regarding each of the ports at the switch.

At operation 308, the networking device may communicate to the data plane to determine where to forward traffic. In one implementation, the networking device may use existing programmed flows to forward traffic. Existing programmed flows may encompass different type of networks, such as SDN networks and legacy networks. Existing SDN programmed flows is the destination path within the SDN network for particular traffic. Using the existing SDN programmed flows, the traffic may continue without disruption. This enables the switch to provide functionality in spite of the failure of the control plane. In another implementation, the control plane may reboot while the data plane forwards traffic. This implementation is described in detail in the next figure.

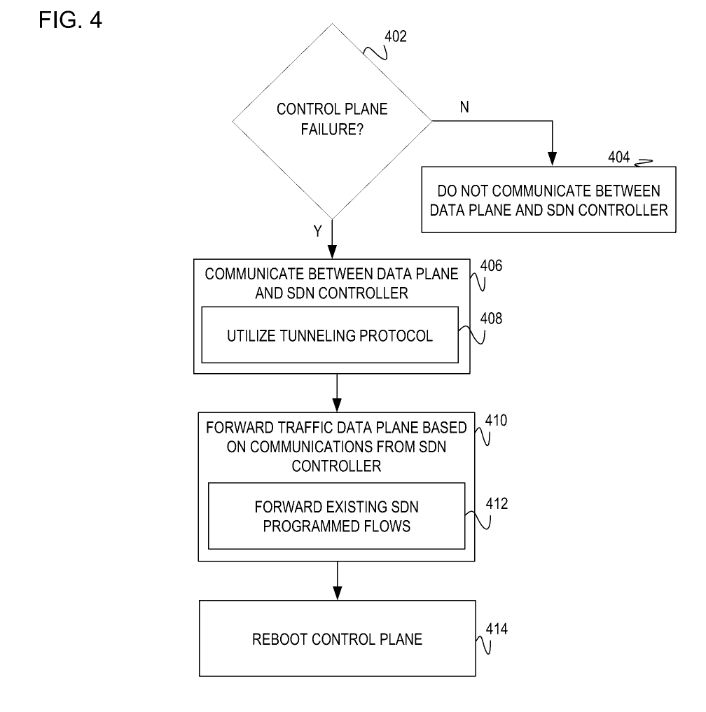

FIG. 4 is a flowchart of an example method executable by a networking device to detect when a control plane suffers a failure and in turn, communicate between a data plane and an SDN controller for forwarding traffic. In discussing FIG. 4, references may be made to the components in FIGS. 1-2B to provide contextual examples. In one implementation, a networking device, such as the switch 104 as in FIG. 1 executes operations 402-414 to detect the control plane failure and forward traffic from the data plane. In another implementation of FIG. 4, the module 112 within the switch 104 as in FIG. 1 executes operations 402-414. Further, although FIG. 4 is described as implemented by the networking device associated with the switch 104 as in FIG. 1, it may be executed on other suitable components. For example, FIG. 4 may be implemented in the form of executable instructions on a machine-readable storage medium 504 as in FIG. 5.

At operation 402, the networking device may detect the control plane failure. The failure of the control plane indicates the control plane is not within normal operation and thus may not be able to determine where incoming traffic should be forwarded. The control plane may signal to the networking device that it may not be within normal operation thus indicating the failure. If the networking device determines the control plane is experiencing failure, the networking device may proceed to operation 406 to communicate the failure to the SDN controller. If the networking device does not detect the control plane failure, the networking device may proceed to operation 404 and does not communicate to the SDN controller. Operation 402 may be similar in functionality to operation 302 as in FIG. 3.

At operation 404, upon detecting the control plane has not experienced a failure as at operation 402, the networking device does not communicate to the SDN controller. If the networking device does not detect the failure or other type of issue at the control plane, this may indicate the control plane is at normal operation. At normal operation, the control plane may receive incoming traffic and determine where incoming traffic should be forwarded. Operation 404 may be similar in functionality to operation 304 as in FIG. 3.

At operation 406, the networking device communicates the failure of the control plane to the SDN controller. The SDN controller may then make an informed decision whether to continue with existing programmed flows according to previously received traffic or to re-program the flows through neighboring switches in the networking system. The SDN controller may then inform the networking device of its informed decision for the data plane to forward traffic accordingly. The SDN controller may also handle future incoming packets that may have not already been programmed for their destination. In this implementation, the SDN controller may receive new flows (e.g., unmatched traffic), to determine where to route the traffic. In one implementation, the networking device may utilize the tunneling protocol as at operation 410 to route the incoming packets to the SDN controller. In this implementation, the virtual tunnel port may be used as both the communication to the SDN controller and transmitting unknown packets. In one implementation, the module may inform the SDN controller about the state of each of the ports on the switch. In this implementation, the module from each line card on the switch informs the SDN controller about each state of the port so the SDN controller may make flow adjustments and/or instruct the switch to bring down a port, etc. For example, the module within each line card on the switch may inform the SDN controller about the SDN enable ports and the non-SDN enabled ports. In this example, the slave module operating within the switch disables the non-SDN enabled port(s) prior to communication with the SDN controller. This allows traffic to flow through the SDN network based on existing programmed flows while blocking traffic through other networks by disabling the non-SDN enabled port(s). For example, traffic may be allowed to flow through the SDN network, while traffic into the legacy network may be blocked. The existing programmed flows are based on traffic the switch has already encountered. Thus, the data plane may already match the traffic which it has already encountered and forward accordingly.

At operation 408, the networking device may utilize a tunneling protocol. The tunneling protocol may be used as a mode of communication to the SDN controller. Tunneling protocol includes when one network protocol (the delivery protocol) encapsulates a different payload protocol. For example, if a layer 3 tunneling functionality is provided by the ASIC within the switch, the encapsulation of the payload may be offloaded to the ASIC. This may also prevent overloading a slave module within the switch as encapsulating the packet enables the packet to be transmitted using the slave module which may be incompatible for the original packet. If the tunneling functionally is not supported in the ASIC of the switch, the auxiliary channel may be maintained by the slave module including the encapsulation of the payload as the layer 3 protocol so the packet may reach the SDN controller.

At operation 410, the networking device communicates to the data plane to forward traffic. As explained in connection with operation 406, the SDN controller may decide to continue with existing programmed flows and thus may communicate this to the networking device. In one implementation, the forwarding table may already exist at the data plane for use in forwarding traffic. In this implementation, prior to the failure, the control plane may direct the data plane where to forward traffic through the use of the forwarding table. As such, the data plane may include the forwarding table.

At operation 412, the networking device may instruct the data plane to forward traffic according to the existing SDN programmed flows. The existing SDN programmed flows specifies the destination path for particular traffic according to the control information which may have been handled previously. In this example, traffic includes at least one packet. The packet includes a payload and control information. The existing SDN programmed flows have previously interpreted the control information to determine the destination path (i.e., flow) in the SDN network. Utilizing the existing programmed flows reduce interruptions to forwarding traffic when a control plane experiences the failure.

At operation 414, the networking device reboots the control plane. The networking device may initiate the reboot upon the detection of the control plane failure. In one implementation, the modules within the switch may remain non-operational during the reboot. In another implementation, during the reboot, the data plane may continue forwarding traffic that matches existing SDN programmed flows. For example, the data plane may use information previously programmed from the control plane to determine where to forward traffic. As such, the data plane refers to the forwarding table to look up traffic and decide how to handle the traffic. Rebooting the control plane enables the functionality of the control plane for determining where to forward incoming traffic. In this implementation, the incoming traffic may be forwarded into a legacy network and/or the SDN network upon establishing functionality post-reboot. Upon the reboot, the control plane may establish communication with the SDN controller over a primary communication channel. In this implementation, flows of incoming packets may be synced in stages. For example, the SDN controller may sync flows which were programmed up until the control plane went down. This further enables the data plane to sync with the control plane for flows that may have been programmed after the control plane failure. Additionally in this implementation, the SDN controller may instruct the switch to continue use of flows which was previously programmed via a primary channel. For example, the SDN controller may transmit instructions to the switch how to handle traffic which may have been incoming post the control plane failure which may have timed out and/or were added during the time the control plane was down. During the reboot of the control plane, the SDN controller may mark the flow (destination path) of incoming traffic as to be added upon the establishment of the control plane. Flows of which have timed out during the reboot may be marked as to be deleted and removed from the networking device.

FIG. 5 is a block diagram of slave module 500 with a processor 502 communicating with a management module 506 over a switch backplane (e.g., switch fabric). The management module 506 with a processor 526 executes instructions 522-524 and the slave module 500 with the processor 502 executes instructions 508-518 with a machine-readable storage medium 504. Specifically, the management module 506 with the processor 526 is to inform of a control plane failure to the slave module 500 and proceed with rebooting the control plane. Specifically, the slave module 500 with the processor 502 is to detect a control plane failure, disable non-SDN enabled port(s) and/or vlans and then forward traffic from a data plane. Although the slave module 500 and management module 506 each include processor 502 and 526, respectively, each module 500 and 506 may include other components that would be suitable to one skilled in the art. For example, the management module 506 may also include the machine-readable storage medium 504 for storing instructions 522-524. The slave module 500 may be similar in structure and functionality to the SDN agent 216 as in FIG. 2B. The management module 506 is capable of managing aspects and/or functioning of the control plane. As such, the management module 506 may include the control plane 108 as in FIG. 1. The instructions 508-524 may be implemented as methods, functions, operations, and other processes implemented as machine-readable instructions stored on the storage medium 504 and/or on the management module 506 which may be non-transitory, such as hardware storage devices (e.g., random access memory (RAM), read only memory (ROM), erasable programmable ROM, electrically erasable ROM, hard drives, and flash memory).

The processors 502 and 526 may fetch, decode, and execute instructions 508-524 to detect the control plane failure within the switch and forward traffic from the data plane based on existing SDN programmed flows. The management module 506 may inform the slave module 500 of the control plane failure and thus reboot the control plane. In one implementation, the processor 526 may execute instruction 522 and the processor 502 may execute instructions 508-518. In another implementation, upon executing instruction 522, the processor 526 may execute instruction 524 while the processor 502 executes instructions 508-518 after or during the execution of instruction 524. The processor 526 executes instructions 522-524 to: inform the slave module of the control plane failure; and reboot the control plane accordingly. The processor 502 executes 508-518 to: detect when the control suffers a failure; disable non-SDN enabled port(s) and/or vlans; forward traffic from the data plane in accordance with communications; communicate the switch status to the SDN controller (not illustrated); receive a communication from the SDN controller; and forward traffic in accordance with existing programmed flows

The machine-readable storage medium 504 includes instructions 508-518 for the processor 502 to fetch, decode, and execute. In another embodiment, the management module 506 may include a machine-readable storage medium including instructions 522-524 for execution by the processor 526. In a further embodiment, the machine-readable storage medium 504 may be an electronic, magnetic, optical, memory, storage, flash-drive, or other physical device that contains or stores executable instructions. Thus, the machine-readable storage medium 504 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 504 may include an application and/or firmware which can be utilized independently and/or in conjunction with the processor 502 to fetch, decode, and/or execute instructions of the machine-readable storage medium 504. The application and/or firmware may be stored on the machine-readable storage medium 504 and/or stored on another location of the slave module 500.

In summary, examples disclosed herein provide a more efficient approach to a networking system when a control plane within a switch suffers a failure. In these examples, the switch which may continue operations despite a control plane failure. This enables the switch to forward traffic based on existing programmed flows without disruption.

We claim:

1. A switch comprising:
a module to:
detect when a control plane within the switch suffers a failure; and
communicate with a software defined networking (SDN) controller; and
a data plane to forward traffic based on communications with the SDN controller.

2. The switch of claim 1, wherein:
a primary channel exists between the control plane of the switch and the SDN controller for communication between the control plane and the SDN controller prior to the switch failure; and
an auxiliary channel exists between the module and the SDN controller for communications upon detection of the failure of the control plane.

3. The switch of claim 1 further comprising:
the data plane to forward traffic without disruption to an existing programmed flow of traffic.

4. The switch of claim 1, further comprising:
an SDN enabled port and a non-SDN enabled port;
wherein the module is to disable the non-SDN port on the switch prior to the data plane forwarding traffic.

5. The switch of claim 1 wherein the module operates as an agent on a line card of the switch or on an application specific integrated circuit (ASIC) of the switch.

6. A non-transitory machine-readable storage medium comprising instructions that when executed by a processor cause the processor to:
detect a control plane failure in a switch;
establish a communication at a data plane in the switch from a software defined networking (SDN) controller; and
forward traffic from the data plane in the switch in accordance with the communication.

7. The non-transitory machine-readable storage medium including the instructions of claim 6 wherein to forward traffic from the data plane in the switch in accordance with the communication is further including instructions that when executed by the processor cause the processor to:
disable a non-SDN enabled port on the switch; and
block a non-SDN enabled vlan.

8. The non-transitory machine-readable storage medium including the instructions of claim 6 wherein to establish the communication at the data plane is further including instructions that when executed by the processor cause the processor to:
communicate over an auxiliary communication channel; and
communicate the control plane failure to the SDN controller.

9. The non-transitory machine-readable storage medium including the instructions of claim 6 further including instructions that when executed by the processor cause the processor to:
forward traffic in accordance with existing SDN programmed flows without disruption.

10. A method, executable by a networking device, the method comprising:
detecting a control plane failure within a switch;
communicating between a data plane of the switch and a software defined networking (SDN) controller; and
forwarding traffic from the data plane based on the communications from the SDN controller.

11. The method of claim 10 further comprising wherein forwarding traffic from the data plane based on the communications from the SDN controller comprises:
forwarding traffic based on existing SDN programmed flows without disruption.

12. A method of claim 10 further comprising:
rebooting the control plane.

13. The method of claim 10 wherein communicating between the data plane of the switch and the SDN controller further comprises:
communicating the data failure to the SDN controller; and
processing traffic in accordance with existing SDN programmed flows.

14. The method of claim 10 wherein the switch is a hybrid switch in an SDN configuration.

15. The method of claim 10 wherein communicating between the data plane of the switch and the SDN controller comprises:
utilizing a tunneling protocol for transmitting traffic to the SDN controller.
